(19) United States
(12) Patent Application Publication
(10) Pub. No.: US 2005/0081457 A1
(43) Pub. Date: Apr. 21, 2005

(54) System and method for training

(75) Inventor: Craig S. Moreo, Westerville, OH (US)

Correspondence Address: MICHAEL BEST & FRIEDRICH, LLP, 100 E WISCONSIN AVENUE, MILWAUKEE, WI, 53202, US

(73) Assignee: Hufcor, Inc., Janesville,, WI (US)

(21) Appl. No.: 10/687,444

(22) Filed: Oct. 16, 2003

(51) Int. Cl. B66B 9/00; E04H 6/06; G09B 25/00

(52) U.S. Cl. 52/29; 434/219

(57) ABSTRACT

A system and method for training. The invention generally includes a method of training service-people, a facility for conducting exercises to train service-people, and a method of converting a facility into a training center. The facility generally includes a plurality of carriers having rollers supported by a grid-shaped track system and movable therein and a panel suspended from each carrier and movable therewith, the rollers permitting movement of the wall panels to form interconnected halls and rooms. The facility may also generally include surveillance systems for observing and recording training exercises executed in the facility. The surveillance systems may generally include a catwalk, a mezzanine with an at least partially transparent floor, and video and audio recording systems.

### BACKGROUND

The invention generally relates to a system and method for training service-people. In particular, the invention relates to movable wall panels supported in a track system. Systems exist involving movable panels for dividing rooms into various sizes. These systems typically include operable wall structures suspended from carriers in a track. The operable wall structures extend all the way across the room and from floor to ceiling to completely separate one portion of a room from another. These systems may alternatively include those in which an operator lifts each wall panel, carries the panel to a desired location, and inserts or fits the panel into a track.

### SUMMARY

The invention generally includes a facility for conducting exercises to train service-people. The facility comprises a floor, a ceiling, a plurality of walls, a track system, a plurality of carriers, and a surveillance system. The track system has a grid-shaped pattern of rails supported below the ceiling. Each carrier has rollers supported by the track system, and a panel suspends from each carrier. The rollers permit movement of the wall panels to define a floor plan of interconnected halls and rooms. The surveillance system is generally mounted above the track system and may include a catwalk, image recording devices, and audio recording devices.

The facility may also include a plurality of elevation systems, and a mezzanine having a partially transparent floor. In addition, the track system may include storage areas for positioning and supporting each panel in a stowed condition.

The invention also generally includes a method of training service-people in the facility. The method includes moving each carrier and the panel suspended therefrom to an operable interconnected halls and rooms with the panels. The method also includes executing a training exercise using the floor plan and monitoring the training exercise with the surveillance system. Monitoring the training exercise with the surveillance system may include positioning an observer on the catwalk or beneath the mezzanine to view the exercise live and in real time, and positioning image and audio recording devices above the track system for recording the training exercise. The image recording devices may be positioned to have a line of sight into substantially all of the interconnected halls and rooms. In addition, the carriers and panels may be rearranged to define alternate floor plans for additional training exercises.

The invention also generally includes a method for converting a facility into a training center. The method includes installing the track system and the catwalk in the facility, providing and movably supporting on the track system the plurality of carriers including rollers, suspending a panel from each carrier such that the panels are movable with the carriers in the track system, and defining interconnected halls and rooms by moving the carriers and panels into a floor plan. The method may also include installing storage areas, a mezzanine, a plurality of elevation systems, and video and audio recording systems, and observing live and in real time the interior of the halls and rooms from the catwalk and beneath the mezzanine.

### BRIEF DESCRIPTION OF THE DRAWINGS

FIG. 1 illustrates an exemplary elevation view of a facility with an exterior wall removed.

FIG. 2 illustrates a perspective view of one configuration of the facility according to one embodiment of the invention.

FIG. 3 illustrates a perspective view of another configuration of the facility according to one embodiment of the invention.

FIGS. 4A and 4B illustrate exemplary configurations of wall panels according to one embodiment of the invention.

FIG. 5 illustrates a top view of a section of the track system according to one embodiment of the invention.

FIG. 6 illustrates a cross-sectional view of the track system according to one embodiment of the invention.

FIG. 7 illustrates a top view of a wall panel in exemplary positions along the track system.

Before the embodiments of the invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

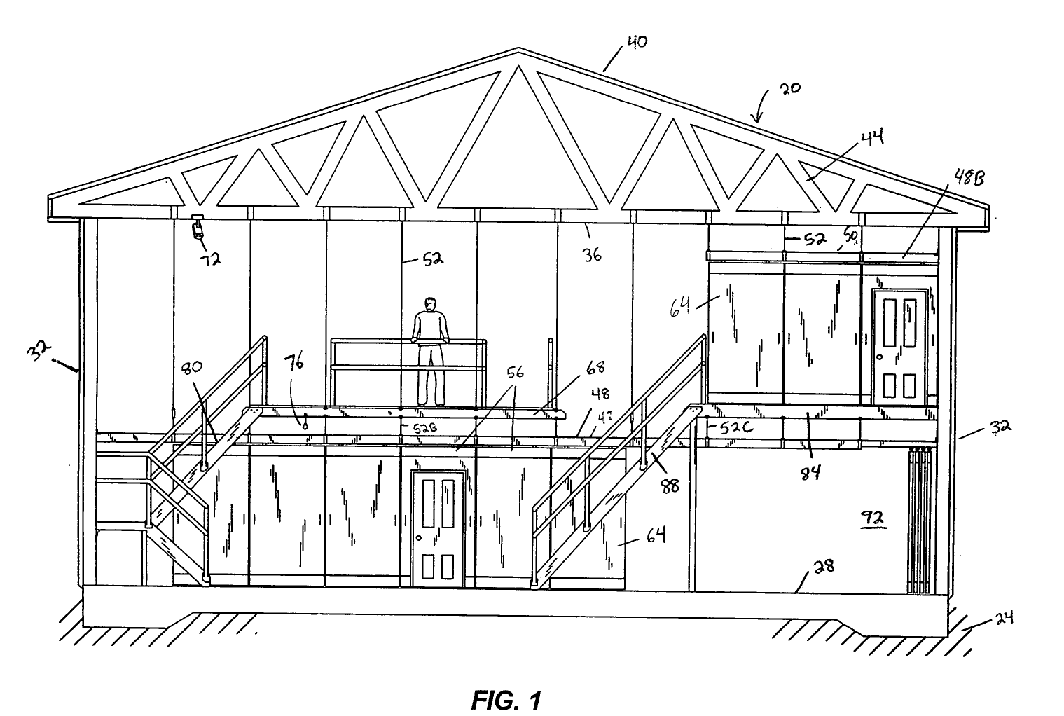

FIG. 1 illustrates a facility 20 having a foundation 24 to support a floor 28 and a plurality of walls 32. The facility 20 also includes a ceiling 36 with a roof 40 and a truss system 44 supported by the walls 32. The facility 20 may be similar to warehouse type buildings and is not limited to the configuration shown. In one embodiment, the facility 20 includes track systems 48 and 48B suspended by cables 52 secured to the truss system 44. It should be noted that the supporting cables 52 may be attached to other structural elements of the ceiling 36. A plurality of wall panels 64 are supported by the track systems 48 and 48B. The wall panels 64 may be arranged to form a floor plan of interconnected halls and rooms. As depicted, the facility 20 includes surveillance systems including, but not limited to, a catwalk 68 and audio and video recording devices such as a camera 72 and microphone 76. As illustrated in FIG. 1, the catwalk 68 is suspended above the track system 48 from the ceiling 36. As shown, the camera 72 is mounted on the truss system 44 above the track system 48 and the microphone 76 is mounted below the catwalk 68. It should be noted that the number and position of the audio and video recording devices is exemplary and that other mounting locations may be chosen that are suitable for recording activity in the facility 20. As discussed in detail below, the catwalk 68 allows an observer to view into the interconnected halls and rooms from above the track system 48. A plurality of elevation systems allow access from the floor 28 to the catwalk 68 and may include steps 80 or any other method of elevation such as a ladder, escalator, or elevator. As shown in FIG. 1, the facility 20 also includes a mezzanine 84 suspended from the ceiling 36, with a plurality of elevation systems leading from the floor 28 up to the mezzanine 84. The elevation systems leading to the mezzanine 84 may include steps 88 or any other method of elevation such as a ladder, escalator, or elevator. In addition, the facility 20 includes a storage area 92 under the mezzanine 84 for positioning and supporting each panel in a stowed condition. The number and position of the storage areas 92 shown in FIG. 1 is exemplary and subject to variation.

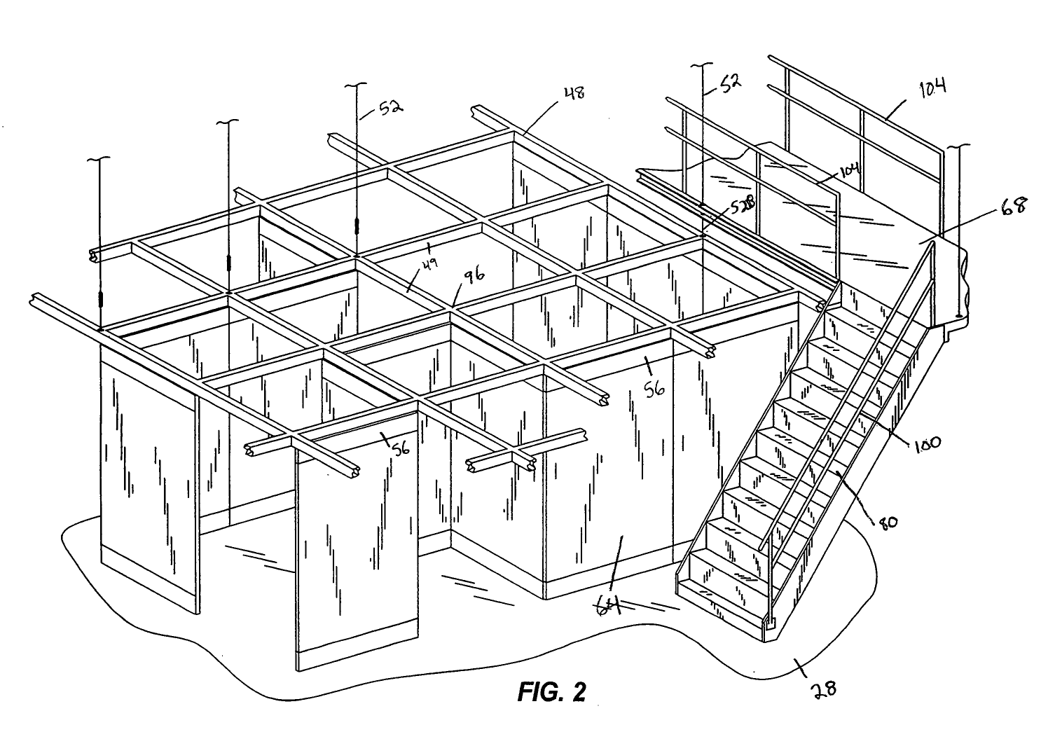

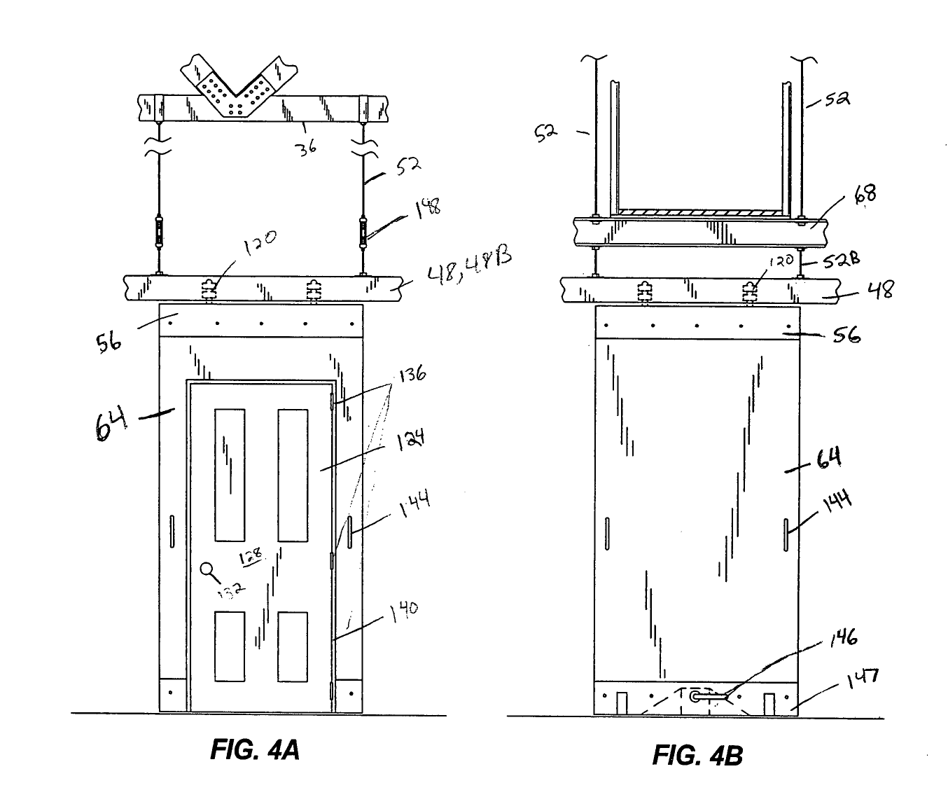

FIG. 2 shows a perspective view of an exemplary configuration of the facility 20. The illustrated track system 48 includes a grid-shaped pattern of rail sections 49 and is suspended from the ceiling 36 by supporting cables 52. As shown, the supporting cables 52 are secured to the track system 48 at the junctions 96 of perpendicular rail sections 49. The supporting cables 52 may be secured to the track system 48 in other positions along the track system 48 as well, instead of or in addition to the junctions 96. The catwalk 68 is also supported from the ceiling by supporting cables 52. As shown in FIG. 2 and also in FIG. 4B, where portions of the catwalk 68 extend between the track system 48 and the ceiling 36, the track system may be supported, as shown, by cables 52B extending from the catwalk 68.

A plurality of carriers 56 are supported by the track system 48 and are movable along the track system. Wall panels 64 are suspended from the carriers 56 and are movable along the track system 48 with the carriers. It should be noted that the number and position of the wall panels 64 is exemplary and that other configurations may be chosen to form various floor plans of interconnected halls and rooms. As shown, the catwalk 68 is above the track system 48 so that an observer on the catwalk can view training exercises live and in real time by looking down into the interconnected halls and rooms. In the configuration of the facility shown, steps 80 allow access from the floor 28 to the catwalk 68, and a handrail 100 is secured to the steps 80 to facilitate elevation up to and descent down from the catwalk 68. The configuration of the facility shown in FIG. 2 also includes handrails 104 secured to the catwalk 68 to facilitate observation of the training exercises.

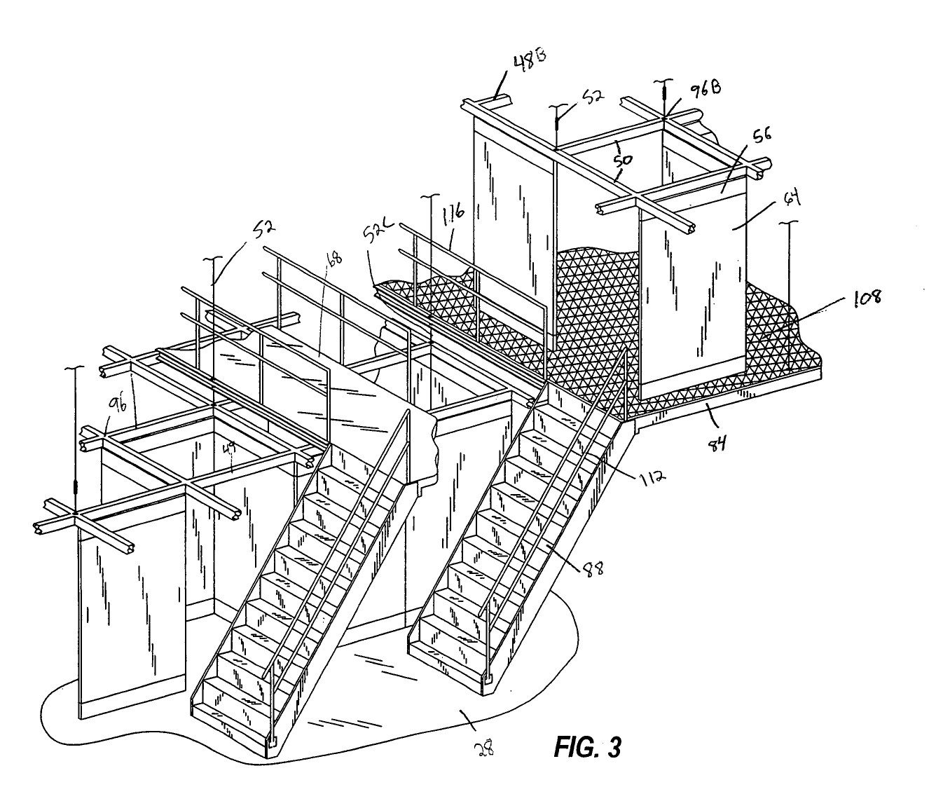

FIG. 3 shows a perspective view of another exemplary configuration of the facility 20, including a mezzanine 84 above the track system 48. In general, the mezzanine 84 may include a partial second floor, story, balcony, or other platforms elevated above the facility floor 28. As shown, the mezzanine 84 is suspended from the ceiling 36 by support cables 52. The mezzanine 84 has an at least partially transparent floor 108 so that an observer can be positioned beneath the mezzanine to observe live and in real time activity on the mezzanine. As used herein, the term “at least partially transparent” means the mezzanine floor 108 may be constructed of any material composition, such as metal grating or plexiglass, that will allow someone to see through the material itself, or through apertures in the material. A track system 48B is suspended above the mezzanine 84, and may be similar to track system 48. As shown, the track system 48B is suspended by cables 52, which may be secured to the truss system 44 or other structural elements of the ceiling 36. As shown, the supporting cables 52 are secured to the track system 48B at the junctions 96B of perpendicular rail sections 50. The supporting cables 52 may be secured to the track system 48B in other positions along the track system as well, instead of or in addition to the junctions 96B. As previously described in relation to track system 48, a plurality of carriers 56 are supported by the track system 48B and are movable along the track system. Wall panels 64 are suspended from the carriers 56 and are movable along the track system 48B with the carriers. It should be noted that the number and position of the wall panels 64 is exemplary and that other configurations may be chosen to form various floor plans of interconnected halls and rooms on the mezzanine 84. In the configuration of the facility shown, steps 88 allow access from the floor 28 to the mezzanine 84, and a handrail 112 is secured to the steps 88 to facilitate elevation up to and descent down from the mezzanine 84. FIG. 3 also depicts handrails 116 secured to the mezzanine 84. Where portions of the mezzanine 84 extend between the track system 48 and the ceiling 36, the track system 48 may be supported, as shown, by cables 52C extending from the mezzanine 84.

It should be noted that the catwalk 68, mezzanine 84, and track systems 48, 48B may be otherwise structurally supported (e.g., with support structure from the floor 28 up, by attachment to the walls 32, or by attachment to each other) by the facility 20, so long as the method of support does not interfere with the movement and positioning of the wall panels 64. In addition, although not illustrated, the facility 20 may also include elevation systems between the catwalk 68 and mezzanine 84.

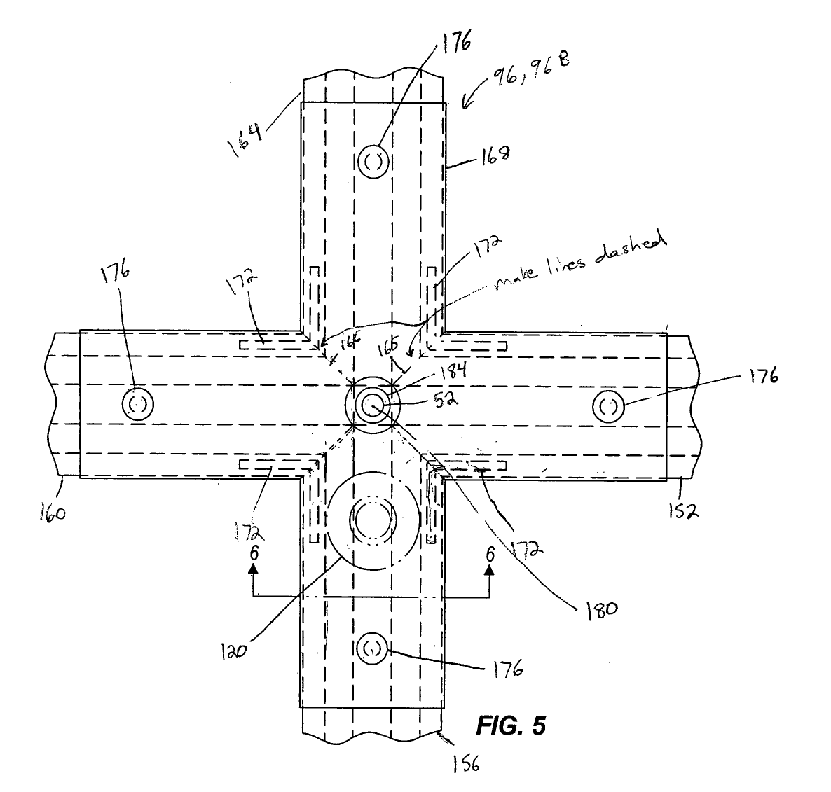

FIGS. 4A and 4B show exemplary configurations of wall panels 64 according to one embodiment of the invention. As shown in FIGS. 4A and 4B, the carriers 56 are supported by roller assemblies 120, which are supported by the track systems 48 and 48B, and a wall panel 64 suspends from each carrier. FIGS. 5, 6, and 7 also illustrate how the roller assemblies 120 are supported by the track systems 48 and 48B. The wall panels 64 may be secured to the carriers 56 by a variety of conventional fasteners. The wall panels 64 may be constructed of any material, and may include a door assembly 124, as shown in FIG. 4A, or any other alterations (e.g., windows or cut-outs) allowing movement from one side of a wall panel to the other by moving through the wall panel. The door assembly 124, as shown in FIG. 4A, includes a door 128, a door knob 132, hinges 136, a door frame 140, and any other components. As illustrated, the wall panels 64 also include handles 144 to facilitate insertion and movement of the wall panels along the track systems 48 and 48B. In addition, as shown in FIG. 4B, the wall panels 64 may include a locking assembly 146 within the bottom portion 147 of the wall panels 64. The locking assembly 146 may be used to secure the wall panels 64 at a desired position along the track systems 48 and 48B. As illustrated in FIG. 4A, the supporting cables 52 may include tensioning devices 148 (e.g., a turnbuckle) to aid in leveling and supporting the track systems 48 and 48B. The supporting cables 52, as shown in FIGS. 4A and 4B, are secured to the track systems 48 and 48B, the ceiling 36, and the catwalk 68 by any means of fastening, such as with a bolt, a rivet, or welding.

FIG. 5 illustrates a top view of an exemplary junction 96, 96B of the track systems 48, 48B according to one embodiment of the invention. As shown, exemplary rail sections 152, 156, 160, 164 fit within a top cap 168, and the ends are mitered so that edges of the individual rail sections butt against edges of two adjacent rail sections. For example, exemplary rail section 164 fits in the top cap 168 so that two of its edges 165, 166 butt against corresponding edges on rail sections 160 and 152. The rail sections 152, 156, 160, 164 are secured to each adjacent rail section by an L-shaped pin 172. Each of the rail sections 152, 156, 160, 164 are also secured to the top cap 168 by a fastener 176, which may comprise a bolt, rivet, screw, staple, or any other means of fastening. In the configuration shown, the track systems 48, 48B are suspended by supporting cables 52 secured to the track systems 48, 48B in the center 180 of each junction 96, 96B. The supporting cables 52 may be secured to the track systems 48, 48B by any means of fastening, such as with a bolt 184, a rivet, or welding.

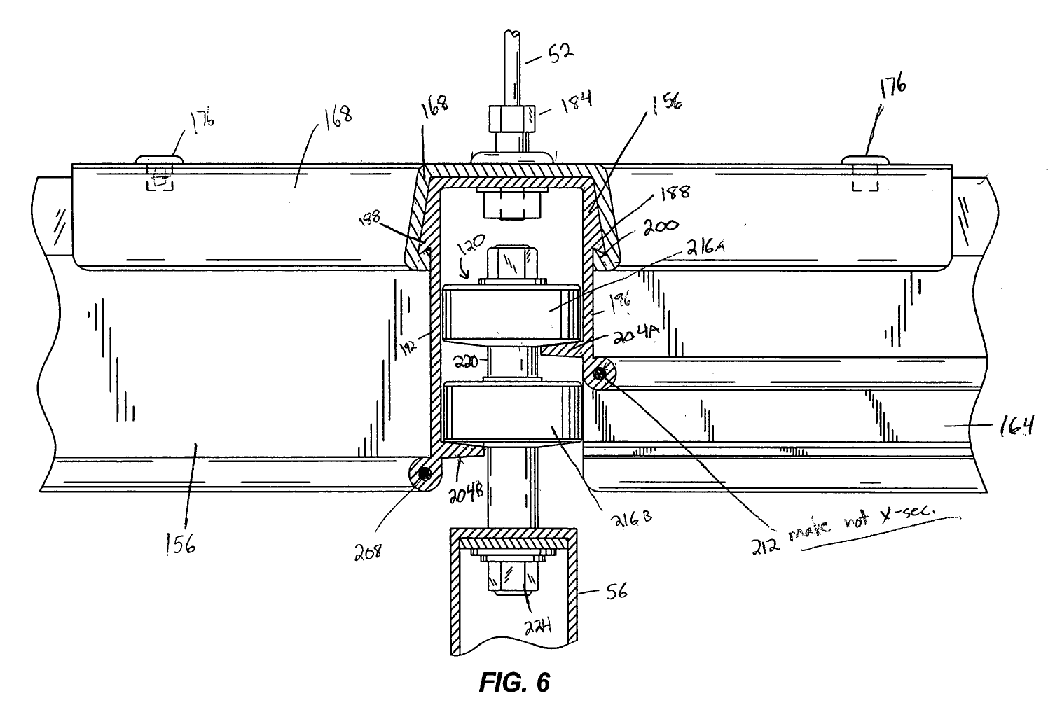

FIG. 6 illustrates a side view of the exemplary junction 96, 96B in FIG. 5, with exemplary rail section 156 shown in cross-section. The rail section 156 includes projections 188 on each side 192, 196 of the rail section, the projections 188 forming an interlocking joint, such as a dovetail, when the individual rail sections are fitted within the top cap 168. The top cap 168 includes a corresponding beveled lip 200 that mates with the projections 188 on the rail sections 156 to form the interlocking joint. As shown, the rail section 156 also includes cavities 208, 212 for receiving interlocking pins 172. As discussed, the pins 172 may be used to connect adjacent rail sections in the junctions 96, 96B. The supporting cables 52 are secured to the top caps 168 and the rail sections 156 by any means of fastening, such as with a bolt 184, a rivet, or welding. In the configuration shown, a carrier 56 is supported in the rail section 156 by a roller assembly 120. The roller assembly 120 includes two rollers 216A, 216B mounted on a shaft 220, which is secured to the carrier 56 by a bolt 224. It should be noted that the roller assembly 120 may be secured to the carrier 56 by a variety of conventional fasteners. In one embodiment, the cross-section of the rail sections 156 includes a plurality of beveled ledges 204A, 204B which support the rollers 216A, 216B. Roller 216A makes contact with and is supported by ledge 204A, and roller 216B makes contact with and is supported by ledge 204B.

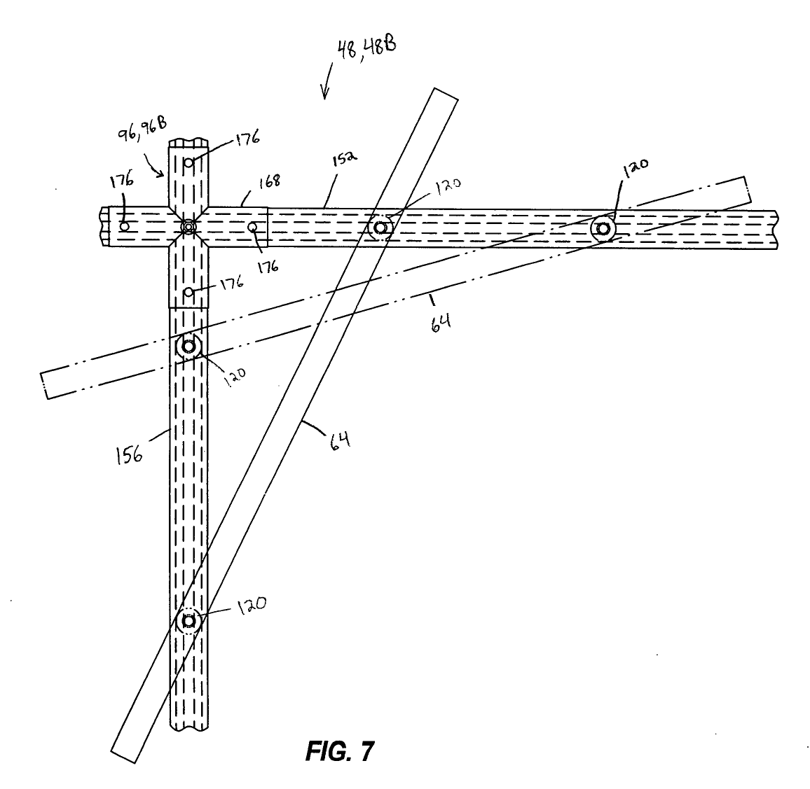

FIG. 7 shows a top view of a wall panel 64 in exemplary positions along the track systems 48, 48B. As shown, the wall panel 64 is suspended from two roller assemblies 120. It should be noted that the number and position of the roller assemblies 120 is exemplary and that many other configurations may be chosen to facilitate movement of the wall panels 64 along the track systems 48, 48B.

With reference to FIGS. 6 and 7, the roller assemblies 120 are movable along the rail sections 156, thereby allowing the wall panels 64 to be moved along the track systems 48, 48B and arranged to form a floor plan of interconnected halls and rooms.

In operation, the facility 20 may be used for, among other things, conducting exercises to train service-people. Once the aforementioned wall panels 64 are arranged to form floor plans of interconnected halls and rooms, training exercises may be executed using these floor plans. The training exercises may be monitored using the various surveillance systems such as the catwalk 68 and the audio and video recording devices such as the camera 72 and microphone 76. Observers can also be positioned beneath the mezzanine 84 to view activity on the mezzanine live and in real time. When desired, the wall panels 64 may be moved by rolling each carrier 56 along the track systems 48, 48B to establish new floor plans, and additional training exercises may be executed and monitored.

An existing facility may be converted into a training center by a method which may include, but is not limited to, installing track systems 48, 48B and a catwalk 68, providing a plurality of carriers 56 secured to roller assemblies 216 such that the rollers 120 are rollable along the rail sections 49, 50, and suspending a wall panel 64 from each carrier such that the panels are movable with the carriers 56. A mezzanine 84 having an at least partially transparent floor 108, as well as surveillance systems such as a camera 72 and microphone 76, may also be installed to facilitate the execution and monitoring of training exercises in the facility.

1. A method of training service-people in a facility having a surveillance system, a grid-shaped track system supported by the facility, a plurality of carriers having rollers supported by the track system and moveable therein, and a panel suspended from each carrier and movable therewith, the method comprising:
(a) moving each carrier and the panel suspended therefrom to an operable position by rolling each carrier along the track system, and thereby establishing a floor plan with the panels;
(b) executing a training exercise using the floor plan;
(c) monitoring the training exercise using the surveillance system;
(d) rearranging the floor plan using step (a); and
(e) repeating steps (b) through (d).

2. The method of claim 1, wherein step (a) further comprises creating a series of interconnected halls and rooms and wherein step (c) includes monitoring into substantially all of the halls and rooms.

3. The method of claim 1, wherein the surveillance system includes a catwalk above the track system and wherein step (c) includes positioning an observer on the catwalk to view the exercise live and in real time.

4. The method of claim 1, further comprising:
providing in the facility a mezzanine having an at least partially transparent floor;
providing between the floor of the facility and the mezzanine a plurality of elevation systems; and
wherein step (c) further comprises positioning beneath the mezzanine an observer for observing live and in real time, through the at least partially transparent floor, activity on the mezzanine.

5. The method of claim 1, wherein the surveillance system includes at least one image recording device and wherein step (c) includes positioning the at least one image recording device above the track system for visually recording the training exercise.

6. The method of claim 5, wherein the surveillance system also includes at least one audio recording device and wherein step (c) includes positioning the at least one audio recording device above the track system for audibly recording the training exercise.

7. A method of training service-people in a facility with a track system having a grid-shaped pattern of rails supported by the facility, a plurality of carriers having rollers supported by the track system and moveable therein, a panel suspended from each carrier and movable therewith, a video recording system, and a catwalk above the track system, the method comprising:
(a) moving each carrier and the panel suspended therefrom to an operable position by rolling each carrier along the track system, and thereby establishing a floor plan of interconnected halls and rooms with the panels;
(b) executing a training exercise using the floor plan;
(c) positioning an observer on the catwalk to view the exercise live and in real time by looking down into the interconnected halls and rooms;
(d) recording the training exercise using the video recording system;
(e) rearranging the floor plan using step (a); and
(f) repeating steps (b) through (e).

8. The method of claim 7, further comprising:
providing in the facility a mezzanine having an at least partially transparent floor;
providing a plurality of elevation systems between the floor of the facility and at least one of the mezzanine and the catwalk; and
wherein step (c) further comprises positioning beneath the mezzanine an observer for observing live and in real time through the at least partially transparent floor activity on the mezzanine.

9. The method of claim 7, wherein step (d) includes positioning the video recording system above the track system such that the video recording system has a line of sight into substantially all of the interconnected halls and rooms from above.

10. The method of claim 7, wherein the facility also has audio recording devices, and wherein the method further comprises recording the exercise with the audio recording devices.

11. A facility for conducting exercises to train service-people, the facility comprising:
a floor;
a plurality of walls supported by the floor;
a ceiling supported by the walls;
a track system having a grid-shaped pattern of rails supported below the ceiling;
a plurality of carriers having rollers supported by the track system and moveable therein and a panel suspended from each carrier and movable therewith, the rollers permitting movement of the wall panels to form interconnected halls and rooms;
a catwalk mounted above the track system and permitting human observation of the interconnected halls and rooms live and in real time; and
a surveillance system mounted above the track system for recording the training exercise.

12. The facility of claim 11, further comprising:
a mezzanine having an at least partially transparent floor; and
a plurality of elevation systems permitting travel between the floor of the facility and at least one of the mezzanine and the catwalk.

13. The facility of claim 11, wherein the track system includes one or more storage areas for positioning and supporting each panel in a stowed condition.

14. A method of converting a facility into a training center, the facility having walls, a ceiling, and a floor, the method comprising:
installing in the facility a track system having a grid-shaped pattern of rails;
installing a catwalk between the ceiling and the track system;
providing a plurality of carriers including rollers;
moveably supporting with the track system the carriers such that the rollers are rollable along the rails;
suspending a panel from each carrier such that the panels are movable with the carriers;
defining interconnected halls and rooms by moving the carriers and panels into a floor plan; and
observing live and in real time from the catwalk the interior of the halls and rooms.

15. The method of claim 14, further comprising:
installing in the facility a mezzanine having an at least partially transparent floor; and
installing a plurality of elevation systems between the floor of the facility and at least one of the mezzanine and the catwalk.

16. The method of claim 14, further comprising installing a video recording system in the facility to record activity in substantially all of the halls and rooms.

17. The method of claim 16, further comprising installing audio recording devices in the facility to record the activity in substantially all of the halls and rooms.

18. The method of claim 14, further comprising installing storage areas for positioning and supporting each carrier and associated panel in a stowed condition.
